(19) United States
(12) Patent Application Publication
(10) Pub. No.: US 2026/0004396 A1
(43) Pub. Date: Jan. 1, 2026

(54) SYSTEM AND TRAINING SYSTEM FOR COMPUTER IMPLEMENTED GENERATING SYNTHETIC IMAGES REPRESENTING COMPRESSED VERSIONS OF ORIGINAL IMAGES

(71) Applicant: ARS SOFTWARE SOLUTIONS AG, Baar (CH)

(72) Inventor: Sebastian WOWRA, Unterägeri (CN)

(73) Assignee: ARS SOFTWARE SOLUTIONS AG, Baar (CH)

(21) Appl. No.: 18/840,012

(22) PCT Filed: Mar. 23, 2023
(86) PCT No.: PCT/EP2023/057536

§ 371 Date: Aug. 20, 2024

(51) Int. Cl. G06T 3/4046; G06T 11/00; G06V 10/74; G06V 10/764; G06V 10/774

(52) U.S. Cl. CPC G06T 3/4046; G06T 11/00; G06V 10/761; G06V 10/764; G06V 10/774

(57) ABSTRACT

A training system for computer implemented training generation of synthetic image data representing a compressed version of original image data comprises an encoder (20) configured to encode original image data (OI) into a latent space representation, a generator (21) configured to generate synthetic image data (GI) based on a latent variable describing a distribution of the latent space representation, and a discriminator (22) configured to evaluate the generated synthetic image data (GI) as to its authenticity. The generated synthetic image data (GI) represents a compressed version of the original image data (OI).

### TECHNICAL FIELD

The invention refers to a system and a training system for computer implemented generating a synthetic image representing a compressed version of an original image, to a corresponding method, to a corresponding training method, and to computer programs corresponding to the methods.

### BACKGROUND ART

Image compression contributes to reducing the amount of space or bandwidth needed to store or transmit data. Image compression can be useful in a variety of daily situations, such as, but not limited to, saving images in a smartphone or laptop and when downloading a file from the internet. Compression can save time and resources.

There are many different techniques that have been used to compress images. In general, images contain repeating patterns or redundancy, where these patterns can be exploited to achieve a better compression ratio. However, decompression can be a tedious task, however, is required on the other hand to transform the compressed image back into the image space.

### DISCLOSURE OF THE INVENTION

A training system is provided for training computer implemented generating synthetic image data representing a compressed version of original image data. The system comprises an encoder configured to encode original image data into a latent space representation. The system further comprises a generator configured to generate synthetic image data based on a latent variable describing a distribution of the latent space representation. The system further comprises a discriminator configured to evaluate the generated image data as to its authenticity. The synthetic image data generated by the generator represents a compressed version of the original image data.

The encoder is a means for producing output data from input data thereby reducing dimensionality of the input data. Accordingly, the output data represents the input data in a more compact and more efficient way. The input data preferably is a vector of given dimensionality, and the output data is a more compact representation of the input vector of lower dimensionality. Accordingly, the encoder encodes and thereby compresses the input vector.

The input data or input vector presently is image data, also referred to original image data. The original image data may represent an original digital image, e.g., produced by a camera. The training includes providing multiple, such as thousands or millions of original images to the encoder, e.g. supplied in multiple batches, and also to the later introduced discriminator. The original image data used for training purposes may also be taken from an image database, such as from one or more of ImageNet® including 14M images in 20K categories, from COCO® including 330K images, CIFAR-10® or CIFAR-100® including of 60K images.

The output data of the encoder is a representation of the input data, i.e., the encoded input data, in latent space. The output data is also referred to as latent representation of the input data, i.e., a latent representation of the original image data.

Preferably, the original image data represents data in an image space. A corresponding data format for storing original image data maybe, e.g., one of png, tif, bmp format. So is the generated synthetic image data to be introduced in more detail later. However, the generated synthetic image data will be requiring less storage space than the original image data, while showing the same content as the original image data. In contrast to the image space, the latent representation of the original image data is hidden in the latent space.

Preferably, the encoder comprises a machine learning model, in particular a neural network being part of a neural network architecture including additional functionalities introduced later on.

Preferably, the encoder is implemented by a fully convolutional neural network. Preferably the encoder comprises a deep learning model.

Preferably, the encoder detects features in the original image data. By means of extracting features from and/or classifying the original image data, the original image data can be represented by a collection of features encoded as latent representation of lower dimensionality than the original image data. The latent representation preferably is a representation of the input data absent noise or redundant information, solely comprising relevant information, which effects its lower dimensionality compared to the input data. Preferably, the encoder is fed with multiple original images for training purposes to enable the encoder to detect features in and/or to classify these training images, such that when a new original image is provided to the encoder, similarities of features are detected between the training images and the new original image. Features may include one or more of structural features such as edges, angles, curves, shapes, etc. color features, patterns, and/or other features in the original image suited for classifying an image.

The process of learning and detecting features in the input data and simplifying the corresponding data representation including comparing the detected features with features of images of the previous training set is hidden. The encoder is responsible for learning and detecting features in the input data and simplifying the corresponding data representation in the latent space.

Accordingly, the encoder is trained to learn a mapping from the input image space to the lower-dimensional latent space, where the learned features are encoded in a more efficient way. This encoding process allows for a more efficient representation of the input data, where the essential features are preserved while redundancies are removed.

In one example, for a better perception of the latent space of an encoder, the encoder is fed with many original images of constructions. The representation in the latent space may show an accumulation of data points, which accumulation is also referred to as cluster, at coordinates in the latent space that represent houses, towers, bridges, etc., A data space between towers and bridges may only scarcely be populated (except for the Tower Bridge in London, for example). Accordingly, images that resemble each other more than others are arranged closer in the latent space because of the similarities of their features than others.

Accordingly, the representation of an original image in the latent space includes the relevant features of the original image data. In other words, the encoder model learns to extract and classify features in original images and simplifies their representation to make them easier to analyze. The representation of an original image in the latent space is modelled as a probability distribution. Hence, the parameters of the distribution (e.g., mean and variance) need to be estimated from the data to define the distribution. Such distribution is typically described by its parameters e.g., mean and variance. During training, the distributions and hence, mean and variance improve given the same original training image in view of the learning of the encoder during the training process. In a preferred embodiment, an estimator is provided and configured to estimate parameters, such as mean and variance, of such a distribution in the latent space representing the original image data. Preferably, the estimator derives from the estimated parameters of the distribution the latent variable that represents a sample in the latent space.

Preferably, the estimator is configured to estimate the parameters of the distribution by applying a maximum likelihood estimation. Maximum likelihood estimation (MLE) is a method for finding parameters, and preferably best-fit parameters for a given statistical model that describes the observed data, which observed data presently is the output data of the encoder i.e., the latent space representation of the original image data. This is preferably done by finding parameter values that maximize a likelihood function, which is a function that describes the probability of observing the data given a set of parameters. The estimator preferably embodies MLE to process initial parameter values for mean and variance of the given statistical model, into optimized parameter values for this given statistical model that achieve the objective of maximizing the likelihood function. Preferably, the given statistical model is a Gaussian function.

The optimized parameters can then be used to make inferences about the underlying latent variables.

Preferably, the estimated parameters of the distribution are used to sample the latent variable. Preferably, the estimator additionally is configured to sample the latent variable form the distribution, or, in other words, to derive the latent variable from the estimated parameter values of the given statistical model. Accordingly, during training with a batch of X original images (e.g., X>10k, or X>100k), a corresponding number of distribution parameter values is determined, and a corresponding number of latent variables is determined.

Examples of the sampling may include one of Importance Sampling or Markov Chain Monte Carlo (MCMC). In Importance Sampling samples are generated from the present distribution and each sample is weighted by a ratio of a target density (i.e., the Gaussian distribution in the latent space) to a density of the present distribution. In Markov Chain Monte Carlo (MCMC) latent variables are iteratively sampled from the present distribution and each sample is accepted or rejected based on a certain criterion.

The generator is fed by the latent variable, i.e., sampled from the distribution as explained above. The generator generates synthetic images in the image space, also referred to as synthetic image data, based on the latent variable.

This synthetic image data resembles the original image data, however, is compressed with reference to the original image data, and, hence, e.g., shows less bytes than the original image data. Therefore, it can be referred to as compressed image, although in traditional approaches compressed images are representations of the original image in the latent space. Presently, instead, the generated synthetic image is a pixel representation in the image space, as is the original image, however, absent redundancy information. At the same time, the generated synthetic image provides for the same or nearly the same visual appeal to a user than the original image. Accordingly, the generated synthetic image is optimized as to storage space and, at the same time, provides good visual quality.

In contrast to conventional approaches, the generator generates the compressed image data synthetically, only based on a latent variable representing a reduced dimensionality representation of the original image, rather than decoding once compressed original image data. This is a major step ahead in compression technologies given that conventional approaches always follow the paradigm of encoding the original image data and decoding the image back from the encoded image data. In contrast, presently the compressed image is:
1) Reduced in storage and/or bandwidth size in case of transmission, however, is available in the image space, and thus requires no additional decoding or decompression for transforming it into the image space. Not only does the generated synthetic image require less storage space and/or bandwidth than the original image. It can be stored and transferred absent the recipient requiring a decoder or decompression tool.
2) Generated “from new” rather than being decoded from the compressed encoded version.

Accordingly, and on an abstract level, the encoder maps an original image into a probability distribution of a given dimension, while the generator interprets images as samples from a dimensional probability distribution in the latent space. In this way, the generator learns to mimic distributions of data. The trained generator, hence, predicts images given a certain probability distribution represented by the latent variable.

The generator preferably is part of a generative adversarial network (GAN), also including the discriminator.

Generative adversarial networks are a class of machine learning models that are used for generating new, synthetic data that is similar to the training dataset. GANs comprise two machine learning models, preferably embodied as neural networks each: a generator and a discriminator. The generator produces synthetic data, while the discriminator attempts to distinguish the synthetic data from real, i.e., original data. The two networks are trained together in an adversarial process, where the generator tries to produce synthetic data that is convincing enough to fool the discriminator, while the discriminator tries to accurately distinguish the synthetic data from the real data. The training process for a GAN involves feeding the generator a random noise input and training both the generator and discriminator to minimize a loss function. The generator tries to minimize a loss by producing synthetic data that is as similar as possible to the real data. Hence, the generator's training objective is to increase the error rate of the discriminator by new data that the discriminator thinks is not synthesized. As the two networks train against each other, the generator becomes more adept at producing synthetic data that is similar to the real data, and the discriminator becomes better at distinguishing synthetic data from real data. What is evaluated in the discriminator is distributions of the generated data compared to distributions of original data.

In the process of training a GAN, the discriminator is initially trained with a real training dataset, and while training continues, with real data sets and generated synthetic datasets. An output of the discriminator preferably is a binomial classifier or a probability variable, the first e.g., reflecting the binary decision true or false, the latter indicating a probability between 0 and 1, i.e., between fake and authenticity.

A result from the evaluation of the discriminator is preferably fed back to the generator, i.e., during training the generator, such that the generator is given feedback whether its generated synthetic data succeeded in fooling the discriminator or not.

The training preferably continues until a defined accuracy threshold is met by the discriminator in distinguishing between synthetic and real data. E.g. the threshold may be defined by “x % of the last y discrimination actions were correct”.

The present invention makes use of the concept of a GAN to produce synthetic data as similar as possible as real data. In the context of the present invention, the synthetic data is the image data generated by the generator, while the real data is the original image data. However, in contrast to conventional GANs, the generator of the present GAN is not fed by random noise input but by the latent variable produced from training or feeding the encoder. Accordingly, the generator is advised to follow a given statistical distribution in generating images rather than to noise.

Accordingly, the generator and the discriminator of the present system are preferably trained machine learning models each, preferably trained neural networks. Herein, the discriminator is preferably a discriminator trained to evaluate the authenticity of image data received. The evaluation preferably includes discriminating between original image data and synthetic image data. And the generator and the discriminator are preferably entities trained to minimize a plurality of loss components of a loss function to improve a realism of the synthetically generated image data.

Hence, the discriminator is configured to determine if the generated synthetic image data provided by the generator is original image data or is image data generated by the generator—of course without knowing the source the image data is supplied from. Preferably, the discriminator is configured to learn and improve its evaluation/assessment based on the result of the evaluation and to adapt parameters of its machine learning model dependent on the result of the evaluation.

In a preferred embodiment, the discriminator is also configured to feed a result of the evaluation back to the generator, i.e., during training the generator. The machine learning model of the generator is configured to learn and improve its generation of synthetic images, and hence, is configured to adapt parameters of its machine learning model dependent on the results of the evaluation.

In a preferred embodiment, the discriminator is a standard convolutional neural network configured to categorize the images fed to it, be it original=real images or generated=synthetic images. In a preferred embodiment, the generator is an inverse convolutional or de-convolutional network, which receives a vector of the latent variable—instead of a vector of random noise as in known GANs- and up-samples it to an image.

Hence, the present GAN is configured to generate synthetic images that are similar to the original images the GAN is trained with. This is affected by transforming a low dimensional latent variable sampled from a distribution from the encoder into a higher dimensional data vector being of sufficiently realistic to fool the discriminator.

Preferably, the system comprises a processing unit, including a local processing unit, but also including a distributed processing entity, which is configured to execute a generative adversarial network including the generator and the discriminator, and preferably additionally or alternatively configured to execute the encoder producing the latent space representation from the original image data, and preferably additionally or alternatively configured to execute the estimator. Preferably, all of generator, discriminator, encoder and estimator are embodied by the processing unit.

Preferably, the generative adversarial network is a Wasserstein generative adversarial network. The Wasserstein Generative Adversarial Network (WGAN) is a variant of a generative adversarial network (GAN) that aims to improve stability. Compared with a conventional GAN discriminator, the Wasserstein GAN discriminator provides a better learning signal to the generator. This allows the training to be more stable when the generator is learning distributions in very high dimensional spaces.

After sufficient training, the generator preferably is configured to generate the synthetic image data based on an original image data being input into the encoder. Accordingly, in particular for testing or production purposes, a system is provided for computer implemented generating a synthetic image representing a compressed version of an original image. Such system comprises the trained encoder and the trained generator of a training system according to any of the preceding embodiments. The trained encoder is configured to receive the original image and encode the original image into a latent space representation. And the trained generator is configured to generate a synthetic image based on a latent variable describing a distribution of the latent space representation. Presently, the term image is used instead of image data, in order to emphasize that it is an individual image that is re-generated to a synthetic image by the trained generator.

In comparison with the training system, the discriminator is no longer required during a test and/or production phase. The generator can be used independently to generate new synthetic images without the need for the discriminator. Preferably, the discriminator is only used during the training phase, and, hence, in the training system setup to provide feedback to the generator and improve the quality of the generated data.

In the system, the trained encoder maps the original image x to a compressed representation in the latent space, a distribution of which representation in the sample space is estimated and sampled for generating the latent variable z. The trained generator then maps the latent variable z back to the synthetic image x′. The distribution p(z|x) is preferably learnt by estimating its parameters using MLE, which allows to sample z from it.

In a preferred embodiment, the system comprises a storage, wherein the generator is configured to store the generated image in the storage. And/or the system comprises a transmission network, wherein the generator is configured to transmit the generated image over the transmission network.

During training, the original image data is fed into the encoder and the discriminator. While the encoder is trained optimizing the representation of the original image data in the latent space, the discriminator is trained on analysing the characteristics of the original image data, including which characteristics make image data original image data. On the other hand, the generator is not trained to minimize distances to specific images but is trained to generate images good enough to fool the discriminator. This enables the GAN of the system to learn in an unsupervised manner.

Hence, during training the generator makes use of a constantly improved latent variable as a basis for generating new, synthetic image data, which generated synthetic image data is evaluated by the discriminator into classes as to being convincing enough to represent original image data or as to being classified as generated image data. In conventional GANs, however, the generator is fed with randomized input in form of a random noise vector that triggers the production of a synthetic image.

In a more mathematical approach, the following is defined:
x represents the original image data points,
p(x) is the distribution of the original image data points,
z is latent variable,
p(z) is the distribution of the latent variable, also referred to as prior distribution,
p(z|x) describes the latent variables z that can be produced by specific original image data x, also referred to as posterior distribution, i.e,. finding the latent variable for a given data point,
p(x|z) defines how to map latent variables to data points; this is used in the generation by the generator;
x′ is the generated image from the generator.

The generator transforms from the latent space to the data space. To generate a data point in the data/image space a latent variable is sampled from the prior distribution p(z).

According to another aspect of the present invention, a computer-implemented method is provided for training the generation of synthetic image data representing a compressed version of original image data. The method is preferably implemented in a training system according to any of the preceding embodiments. The training comprises the steps of receiving original image data and training the discriminator by the received original image data. This enables the discriminator to extract features, properties, and/or characteristics from original images that account for original images. Preferably, the discriminator is also trained by the image data generated by the generator, i.e., synthetic images. Again, this enables the discriminator to extract features, properties, characteristics from synthetic images that account for synthetic images.

During training the discriminator, the discriminator preferably evaluates the authenticity of the received image—be it an original image or a synthetic image-, which preferably includes determining if the received image data is an original image data or is an image data generated by the generator. The determination, also referred to as classification, preferably results in a discriminator output indicating if the received image data is an original image or is a synthetic image generated by the generator. In the preferred case of a Wasserstein GAN, the discriminator output is a real number representing the difference or distance between the real images and generated images distribution. The output of the WGAN discriminator, also referred to as critic, can be normalized by several techniques, e.g., rescaling and clipping the critic's output.

Preferably, the training of the critic includes adapting parameters of a machine learning model of the critic during training. Preferably, the critic makes use of and back-propagates findings into the critic's model, thereby adapting parameters and/or weights of its machine learning model which adapted parameters and/or weights shall improve evaluation results in the future compared to past evaluation results based on the previously non-adapted parameters and/or weights.

Preferably, the generator is also trained, preferably by backpropagating the evaluation results to the generator and making use of the evaluation results in the generator. Training the generator thereby includes adapting parameters of a machine learning model of the generator dependent on the result of the evaluation. For this purpose, the discriminator in particular feeds back the result of an evaluation to the generator. The generator may assign the result to the dedicated synthetic image produced and find, that it was sufficiently good in case the evaluation in the discriminator evaluated this image as original image; or it may find it was not produced sufficiently good for the discriminator in case the discriminator evaluates the image as synthetically produced. Adapting parameters of the machine learning model of the generator results in adapted parameters providing improved generated image data over the non-adapted parameters, wherein the improved generated image data is image data more likely to be evaluated by the discriminator as original image data.

In a preferred embodiment, the encoder is trained by original image data, and preferably by the same original image data the discriminator is trained with. While training, the encoder encodes the received original images into latent space representations. The adaption of the parameters happens in the backpropagation, which involves computing the gradients of the loss function with respect to encoder's weights and parameters and updating them accordingly. This preferably results in the encoder adapting parameters of its machine learning model. Preferably the adapted parameters provide improved future detection of features in the original image data over the non-adapted parameters.

In an embodiment, the encoder is part of an auto-encoder additionally comprising a decoder. Parameters of the machine learning model of the encoder are preferably adapted dependent on image data produced from the decoder from the latent space representation provided by the encoder. The following different training concepts are preferred: The encoder may preferably be trained first, and independent from the GAN, i.e., disconnected from the GAN. There are two ways in continuing the training after the encoder is considered trained: The discriminator and the generator are trained in combination but decoupled from the output from the encoder, i.e., the generator is fed with random noise while the discriminator is fed with original images. Here, the GAN and the encoder are trained independent from each other, before being coupled (encoder-generator coupling). Finally, all components (encoder, generator, discriminator) are continued to be trained together.

In the alternative, the GAN including generator and discriminator are coupled to the trained encoder, wherein the generator is trained by the output of the encoder, i.e., with its latent variables as input, and the discriminator is additionally trained with original images.

There are more variants possible: In two sub-variants, the discriminator can be trained first with original images only, while after a while the generator is activated and trains the discriminator also with synthetic images. Hence, first the discriminator is exposed to original training images only, while after a while the discriminator receives original images and images from the generator alongside, for training purposes.

In a different embodiment, the encoder, the discriminator and the generator are trained simultaneously by the same original images. This approach may apply from the beginning of the training, or it may apply after individual training of components of the system, such as after having trained the encoder.

Training the generator and the discriminator involves minimizing the respective loss functions: LG=Error (D(G(z)),1), and LD=Error (D(x),1)+Error (D(G(z)),0), wherein LG is the generator loss, LD is the discriminator loss, Error is an error function, and specifically is the Earth Mover's Distance EMD in case of a Wasserstein GAN used, x is the original image data, z is the latent variable, G(z) is the generated synthetic data from the generator, D(G(z)) is the discriminator's evaluation of the generated synthetic image data, and D(x) is the discriminator's evaluation of the original image data.

It is preferred that the accumulated loss LG+LD is minimized. A threshold for the accumulated loss can be pre-defined for stopping the training routines, i.e., at this point in time the quality of the generated synthetic images is considered as sufficiently good, and the discriminative properties of the discriminator are considered as sufficiently good to start production of generating synthetic images.

In a preferred embodiment a regularization loss function is applied between the distribution of the latent representation produced by the encoder and the distribution obtained by the latent variable. Regularization is important for the prevention of overfitting. Overfitting occurs when the model is too complex and fits the training data too closely, resulting in a poor generalization performance when making predictions on new, unseen data.

Presently, regularization is a measure of the difference between the distribution of the latent representation produced by the encoder also referred to as the posterior, and the prior distribution that is obtained from the latent variable. It is further preferred, that the Wasserstein distance, also known as the Earth Mover's Distance (EMD), is used in the present model for regularization purposes. The Wasserstein distance measures the minimum cost required to transform one distribution into the other, in the present case the assumed posterior into the prior. The corresponding loss function for the regularization is:

$${L}_{reg} = EMD ( p ( z \vert x ) , p ( z ) ) ,$$

where L_{reg} is the regularization loss,
p(z) is the prior of the latent variable z, and
p(z|x) is the assumed posterior from the encoder.

In a preferred embodiment, a perceptual loss function is applied to the system. Perceptual loss functions are loss functions used to capture a similarity between two images (the original and the compressed/generated images) in a more human-interpretable way. These loss functions are based on the idea that the high-level features of an image, such as texture, edges, and shapes, are more important for determining the similarity between images than the pixel-level differences. In the present system, it is preferred to use a pre-trained deep neural network residual network (ResNet) as a feature extractor. Activations of this network for both the original and generated synthetic images are compared. A difference between the activations is then used as the basis for the perceptual loss. A final classification layer of the ResNet is preferably removed to obtain the activations, which in turn are used to measure the image's perceptual similarity. The loss between the activations of the generated synthetic image (GI) and the ground truth original image (OI) is referred to as the perceptual loss Lperc and can be obtained by:

$$Lperc = MSE ( activations GI , activation OI )$$

where MSE is the Mean Square Error used to calculate the distance between activations of GI which refers to the generated image and the activations of OI which refers to the original image.

Accordingly, in the preferred embodiment, a perceptual loss function configured to capture a similarity between the original image and the generated synthetic image is applied to the system/model, preferably wherein the perceptual loss function includes a difference between activations for the original image data and the generated synthetic image data.

For the overall system, it is preferred that a loss functions Ltotal is applied, which means that during training the system this loss function is optimized in the processing unit as to minimize it:

$$Ltotal = Lgen + Lreg + Lcritic + LWANg + Lperc$$

wherein:
Lreg=EMD (p(z|x), p(z)), which is the regularization loss introduced above,
Lperc=MSE (activations GI, activation OI), which is the perceptual loss introduced above,
Lgen is the generation loss, which is MSE(x′,x)
Lcritic is the loss of the discriminator, which is the Wasserstein distance or difference between the distributions of real and generated data. Lcritic=
LossD=E[f(x)]−E[f(x′)], where f(x) and f(x′) are the critic's output over the real and generated data respectively,
LWGANg is the loss of the generator of the WGAN, which is the negative of the output of the critic while feeding on the generated image, −D(G(z)).

Taking the view from optimization, the encoder receives the original image and creates the latent space. If the latent space follows a specific distribution, such as a Gaussian distribution, parameters of this distribution are preferably initiated. Preferably, the parameters are then optimized by using Maximum Likelihood Estimator (MLE). The optimized parameters may then be used to infer the latent variable. The latent variable is input to the generator to generate a new synthetic image, which represents a compressed image related to the original image. The generated synthetic image is fed into the discriminator, where the discriminator evaluates if the generated synthetic image is synthetically produced or is an original image.

A loss function used between the generated image x′ and the original image x is MSE, referred to as the generation loss Lgen above. The regularization loss Lreg is the loss between the prior p(z) of the latent variable and the posterior p(z|x) assumed from the encoder, and preferably is the Wasserstein function. Preferably, the Wasserstein function is also used to train the discriminator by minimizing the distance between the real and generated data distributions, in other words the difference between the average output of f(x) over the real data and the average output of f(x′) over the generated data, where x′ is a generated image produced by the generator, this is referred to as critic loss Lcritic. The loss function of the generator LWGANg is the negative of the output of the critic while feeding on the generated synthetic image, −D(G(z)). Finally, the perceptual loss Lperc compares high-level features of the two images (generated and original), extracted using the ResNet. By comparing the activations of intermediate layers, perceptual loss functions capture the similarity between the two images at a semantic level, rather than a pixel-level (pixel level is the MSE between original and generated images). This results in a more robust comparison between the images, and a more visually appealing output.

According to another aspect of the present invention, a computer program is provided that is configured to cause a computing system, preferably a system according to any of the preceding embodiment, to carry out the training method according to any one of the previous embodiments, if the computer program is carried out by a processing unit of the computing system.

According to a further aspect of the present invention, a computer-implemented method is provided for compressing image data in a system according to any of the preceding embodiments. The method comprises providing original image data representing an original image to the encoder, encoding the original image data by the encoder into a latent space representation, estimating a latent variable describing a distribution of the latent space representation, and generating synthetic image data by the generator from the latent variable, wherein the generated synthetic image data represents a compressed version of the original image data, and preferably is produced by a trained GAN. Preferably, the generated synthetic image data is stored or is transmitted over a transmission network.

According to a further aspect of the present invention, a training system is provided comprising a processing unit configured to conduct a training method according to any of the preceding embodiments. to a further aspect of the present invention, a computer program is provided that is configured to cause a training system of any of the previous embodiments, and preferably its processing unit, to carry out the training method according to any one of the preceding embodiments.

According to a further aspect of the present invention, a synthetic image is provided that is generated by a training system or by a system according to any of the preceding embodiments, or by a method or a training method according to any of the preceding embodiments.

Other advantageous embodiments are listed in the dependent claims as well as in the description below.

### BRIEF DESCRIPTION OF THE DRAWINGS

The invention will be better understood and objects other than those set forth above will become apparent from the following detailed description thereof. Such description makes reference to the annexed drawings, wherein:

FIG. 1 shows a block diagram of a training system for computer implemented training generation of synthetic image data representing a compressed version of original image data, according to an embodiment of the present invention;

FIG. 2 shows a block diagram of a system for computer implemented generating a synthetic image representing a compressed version of an original image, according to an embodiment of the present invention;

FIG. 3 illustrates, in a block diagram, a training method according to an embodiment of the present invention;

FIG. 4 illustrates in a block diagram, a further training method according to an embodiment of the present invention; and

FIG. 5 illustrates a flow chart illustrating a training method according to and embodiment of the present invention, as well as a method according to an embodiment of the present invention.

### MODES FOR CARRYING OUT THE INVENTION

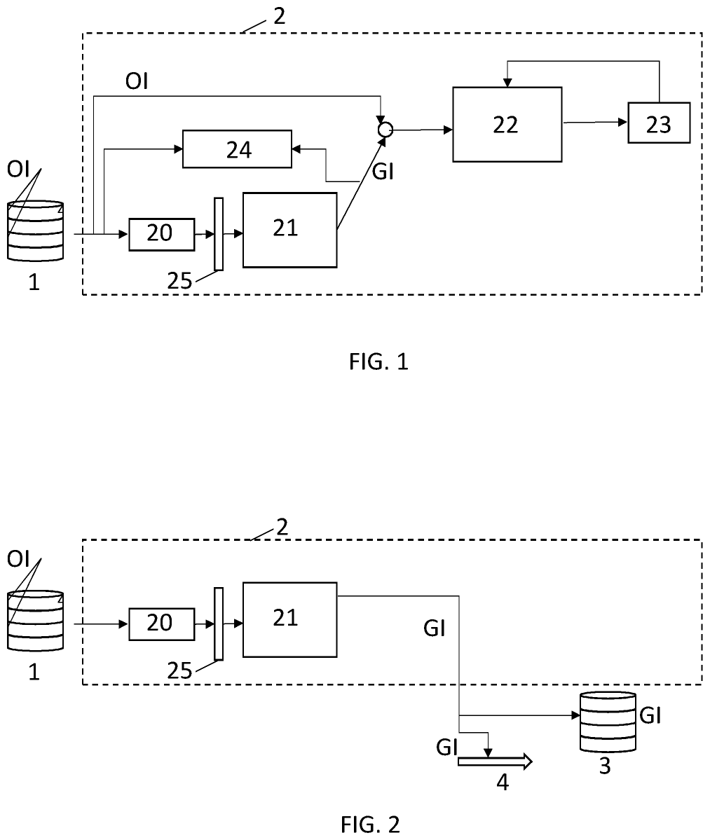

FIG. 1 illustrates a block diagram of a training system for training computer implemented generation of synthetic image data representing a compressed version of an original image data, according to an embodiment of the present invention.

The system comprises a processing unit 2 and a storage 1 for storing original images OI, e.g., pictures taken by a camera or from a database, such as a training database. The processing unit 2 may be the processing unit of a computing entity, such as a personal computer. The processing unit 2 may be a remote processing unit in the cloud or may be a distributed processing unit.

The processing unit 2 includes an encoder 20, a generator 21 and a discriminator 22 as key elements. The encoder 20 receives the original images OI and encodes the original images OI into a latent space representation. For this purpose, it is preferred that the encoder 20 is embodied as convolutional neural network, hence as machine learning entity, which preferably is trained in encoding original images OI in a latent representation of lower dimensionality in the latent space, which latent space is indicated by reference numeral 25. Additional means maybe provided, but not illustrated in FIG. 1 to sample the probability distribution in the latent space 25 and provide a latent variable. Such means may include an estimator configured to estimate parameters of the probability distribution in the latent space 25.

The latent variable is input to a generator 21. Accordingly, the generator 21 generates an image x′ from a latent variable sampled from a probability distribution, preferably a Gaussian distribution. This generated image is referred to as generated image GI, or as generated synthetic image. The loss function of the generator also referred to as LWGANg depends on the feedback of the discriminator while training the generator, and it is the negative of the output of the critic while feeding on the generated image, −D(G(z)). Preferably, the generator 21 is embodied as a neural network and is part of a generative adversarial network GAN, together with the discriminator 22. The discriminator 22 is provided to discriminate the images received as original images or as synthetic images, aka fake images, generated images, etc. During training, the generator 21 and the discriminator 22 compete with each other in that the generator 21 improves in producing generated synthetic images GI of a quality the discriminator 22 may no longer discriminate from original images OI, while the discriminator 22 improves in discriminating generated synthetic images GI from original images OI.

Accordingly, the discriminator 22 is trained by receiving original images OI, e.g., direct from the source, which presently is storage 1. And the discriminator 22 receives generated synthetic images GI from the generator 21. Preferably, the discriminator 22 has a feedback loop including a loss determination 23. Here, the loss is determined by minimizing the distance between E[f(x)] which represents the average output of the discriminator over the real data and E[f(x′)] which represents the average output of the discriminator over the generated data:

$${L}_{critic} = E [ f ( x ) ] - E [ f ( {x}^{′} ) ]$$

It is desired that both loss functions of the GAN are minimized during training the generator—discriminator model, or in other words, during training the WGAN of the system.

In addition, so-called activations 24 are determined, and a perceptual loss is determined in block 24. The activations 24 are derived from the original image OI and the generated image GI, and provide a semantic similarity as also introduced above.

The system introduced in FIG. 1 represents a training system to train the encoder and the GAN. For test or production of compressed images, preferably the trained encoder 20 and the trained generator 21 of the GAN are used, while the discriminator no longer is needed. FIG. 2 illustrates such system for generating compressed images. The components correspond to the ones of FIG. 1, however in a trained status. The discriminator is no longer needed. In addition, a storage 3 is provided for storing generated image data GI, which are understood as compressed versions of the original image data OI, and/or a transmission network 4 to transmit the generated, compressed images GI elsewhere. Storages 1 and 3 maybe embodied as a single storage or may be different storages.

The training mode, and hence the training system can be left in case of sufficient training. Sufficient may, for example, indicate, that the discriminator can distinguish original from generated images at a likelihood of 98%, for example. In turn, this means that the generator 21 is as good in generating synthetic images that it is almost no longer possible for the discriminator 22 to detect these as fake. This represents a quality measure for the generator 21. Given that the generator 21 is assumed to provide synthetic images GI that nearly perfectly match the original images OI, however, while at the same time consuming less storage space, those generated synthetic images GI may be ready to be operationally used.

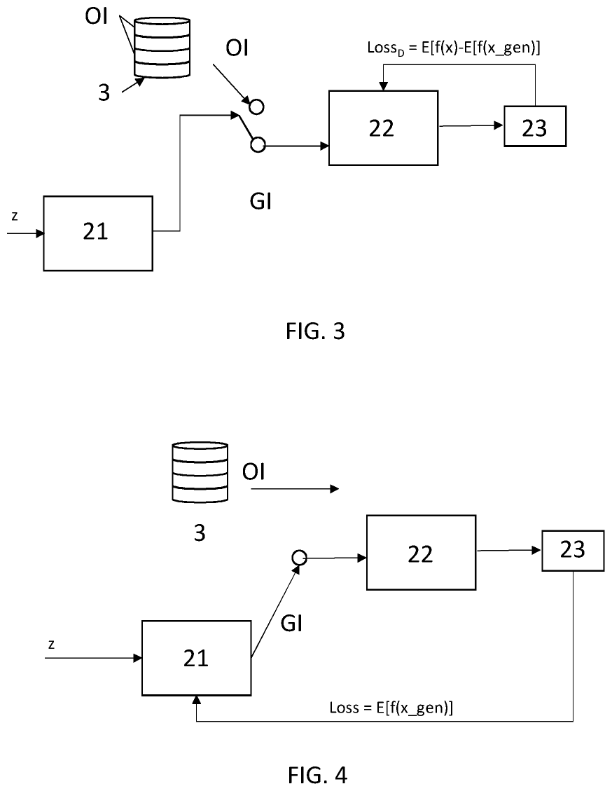

FIG. 3 illustrates, in a block diagram, a training method according to an embodiment of the present invention. Presently, only the GAN portions are illustrated, i.e. the generator 21 and the discriminator 22, as well a representation of the loss function 23 in the feedback loop of the discriminator 22 when training the discriminator 22 and feedback loop to the generator 21 when training the generator 21. This chart illustrates the training of the discriminator 22 of the generative adversarial network. The discriminator 22 is expected, by providing the discriminator 22 with sufficient sample images, to be trained to discriminate original images from synthetically generated images, e.g., the ones generated by the generator 21. Accordingly, the discriminator 22 is supplied by original images OI and generated images GI, as can be derived from FIG. 2, e.g. alternately as indicated by the switch in FIG. 2. There maybe a different scheduling in supplying original images OI and generated synthetic images GI to the discriminator 22. For example, the discriminator 22 may first be fed solely with original images OI, while only after a while, generated images GI are intermingled into the stream of original images OI. Or only generated images GI may be supplied to the discriminator 22 after the period in which solely original images OI were supplied to the discriminator 22. Preferably, the discriminator 22 learns, by way of the feedback, which of his decisions were right, which were wrong. In this context, the discriminator adapts its weights or parameters, and tries to improve its functionality.

FIG. 4 illustrates a further training method according to an embodiment of the present invention in a block diagram. Again, only the GAN portions are illustrated, i.e. the generator 21 and the discriminator 22, as well a representation of the loss function 23 in the feedback loop of the discriminator 22 when training the discriminator 22 and in the feedback loop of the generator 21 when training the generator 21. This chart now illustrates the training of the generator 21 of the generative adversarial network. The generator 21 is expected, by providing the discriminator 22 with sufficient feedback on generated images GI, to be trained to improve the generation of synthetic images, preferably to such a level, that the discriminator 22 no longer is, or is hardly any longer capable to discriminate between an original image OI and a generated image GI, e.g., one generated by the generator 21. Accordingly, the generator 21 generates synthetic images from a latent variable derived from a noise distribution, or, more appreciated, from a distribution provided by the encoder 20 of FIG. 1. Then, the discriminator 22 is supplied by the generated images GI, as can be derived from FIG. 4. The discriminator 22 does not receive original images OI during this phase. Preferably, the loss function 23 represents the error of a generated image GI being detected as fake, image in the discriminator 22. This result is fed back to the generator 21, which learns, based on this feedback, to generate more realistic images that may convince the discriminator 22 in the future to be original images.

Preferably, during the training phase of the discriminator 22, the discriminator 22 learns, by way of the feedback, which of his decisions were right and which were wrong. In this context, the discriminator 22 adapts its weights or parameters, and tries to improve its discrimination capability.

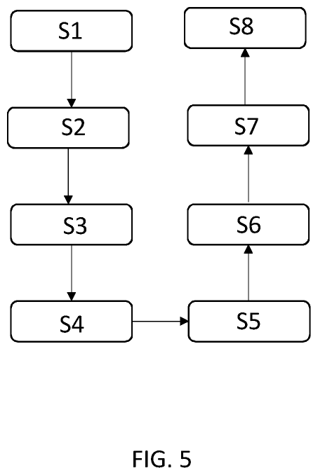

FIG. 5 illustrates a flow chart illustrating a training method according to and embodiment of the present invention, as well as a method according to an embodiment of the present invention.

In step S1, training data in form of original images are provided. In step S2 the original images maybe pre-processed, if needed (optional step). In step S3, the encoder is trained with the original images. Preferably a semantic map is generated from the original images, resulting in a distribution of features for the multitude of original training images in the latent space. This latent space representation is estimated in step S4, e.g., by an estimator. The estimator estimates parameters of the probability distribution in the latent space from which the latent variables are inferred in step S5. In step S6, the GAN is trained by original images and by synthetic images generated by the generator of the GAN based on the latent variables.

After training of the GAN, the training method is terminated, at least as the usability of the system is concerned. Hence, at that point in time the system can be used to generate space reduced synthetic images relating to original images, the latter requiring more memory space. In step S7, such original image to be compressed is fed into the encoder and triggers a generation of a synthetic image by the generator. In step S8 this generated synthetic image is stored and/or transmitted elsewhere.

1. A training system for training computer implemented generation of synthetic image data representing a compressed version of original image data, comprising:
an encoder configured to encode original image data into a latent space representation,
a generator configured to generate synthetic image data based on a latent variable describing a distribution of the latent space representation, and
a discriminator configured to evaluate the generated synthetic image data as to its authenticity,
wherein the generated synthetic image data represents a compressed version of the original image data.

2. The training system according to claim 1,
wherein the encoder comprises a machine learning model configured to encode the original image data into a latent space representation of reduced dimensionality compared to the dimensionality of the original image data,
wherein the discriminator comprises a machine learning model configured to determine if the supplied image data is original image data or is image data generated by the generator,
wherein the discriminator is configured to feed a result of the evaluation back to the generator,
wherein the generator comprises a machine learning model,
wherein the generator is configured to adapt parameters of its machine learning model dependent on the result of the evaluation.

3. (canceled)

4. The training system according to claim 2, comprising
a processing unit configured to execute a generative adversarial network including the generator and the discriminator,
wherein the discriminator is a discriminator trained to evaluate the authenticity of image data received, preferably to discriminate between original image data and synthetic image data,
wherein the generator and the discriminator are entities trained to minimize a plurality of loss components of a loss function to improve a realism of the synthetic image data,
wherein the processing unit is configured to execute the encoder producing the latent space representation from the original image data,
preferably wherein the generative adversarial network is a Wasserstein generative adversarial network.

5.-6. (canceled)

7. The training system according to claim 3, comprising
an estimator configured to estimate parameters of the distribution of the latent space representation and configured to determine the latent variable based on the estimated parameters,
wherein the processing unit is configured to execute the estimator producing the parameters of the distribution from which the latent variable is inferred.
preferably wherein the estimator is configured to estimate the parameters of the distribution by applying a maximum likelihood estimation.

8. (canceled)

9. A system for computer implemented generating a synthetic image representing a compressed version of an original image,
comprising the trained encoder and the trained generator of the training system according to claim 1,
wherein the trained encoder is configured to receive the original image and encode the original image into a latent space representation,
wherein the trained generator is configured to generate a synthetic image based on a latent variable describing a distribution of the latent space representation.

10. The system according to claim 9, comprising one or more of
a storage, wherein the generator is configured to store the generated image data in the storage, and
a transmission network, wherein the generator is configured to transmit the generated image data over the transmission network.

11. A synthetic image generated by the system according to claim 9.

12. A computer-implemented method for training generation of synthetic image data representing a compressed version of original image data, in a training system according to claim 1, wherein the training comprises the steps of:
receiving original image data, and
training the discriminator by the received original image data.

13. The training method according to claim 12, comprising:
training the discriminator by the image data generated by the generator,
wherein training the discriminator includes evaluating the authenticity of the received image data including the received original image data and the received generated image data,
wherein training the discriminator includes adapting parameters of a machine learning model of the discriminator dependent on the result of the evaluation,
preferably wherein evaluating the authenticity of the received image data includes determining if the received image data is original image data or is image data generated by the generator,
preferably wherein a result of the evaluation is a classifier indicating if the received image data is original image data or is image data generated by the generator,
preferably wherein the classifier is represented by a real number indicating if the received image data is original image data or is image data generated by the generator, wherein the higher the number is the more realistic the fed-in image is to the discriminator,
preferably wherein adapting parameters of the machine learning model of the discriminator results in adapted parameters providing improved evaluation results over the non-adapted parameters.

14.-15. (canceled)

16. The training method according to claim 13,
comprising training the generator,
wherein training the generator includes adapting parameters of a machine learning model of the generator dependent on the result of the evaluation,
preferably wherein adapting parameters of the machine learning model of the generator results in adapted parameters providing improved generated image data over the non-adapted parameters, wherein the improved generated image data is image data more likely to be evaluated by the discriminator as original image data.

17. The training method according to claim 12,
training the encoder by the received original image data (OI), where the encoder is trained depending on the total loss function by updating its weights and parameters during backpropagation,
wherein training the encoder by the received original image data includes encoding the received original image data into a latent space representation,
wherein training the encoder includes adapting parameters of a machine learning model of the encoder dependent on the loss function to produce better latent space representations,
wherein adapting parameters of the machine learning model of the encoder results in adapted parameters providing improved evaluation in detecting features in the original image data over the non-adapted parameters.

18.-20. (canceled)

21. The training method according to claim 17, comprising:
training the encoder prior to training the discriminator,
training the discriminator with images generated by the generator based on the latent variable describing a distribution of the latent space representation provided by the encoder when trained by the original image data,
encoding the original image data by the encoder into a latent space representation,
estimating the parameters of the distribution from which the latent variable is inferred,
generating the image data by the generator based on the latent variable,
providing the generated image data to the discriminator for training the discriminator to classify the provided generated image data as image data generated by the generator,
providing the original image data to the discriminator for training the discriminator to classify the provided image data as original image data.

22.-23. (canceled)

24. The training method according to claim 17, comprising
training the encoder independent from the discriminator,
preferably training the discriminator with images generated by the generator based on the latent variable describing a noise distribution.

25. The training method according to claim 12, comprising:
training the discriminator concurrently with training the encoder, and
preferably training the generator concurrently with training the encoder.

26. The training method according to claim 12,
wherein training the generator and discriminator comprises minimizing the loss functions:
$$LG = Error ( D ( G ( z ) ) , 1 ) ,$$
$$LD = Error ( D ( x ) , 1 ) + Error ( D ( G ( z ) ) , 0 ) ,$$
wherein:
LG is the generator loss,
LD is the discriminator loss,
Error is the error function,
x is the original image data,
z is the latent variable,
G(z) is the generated synthetic data from the generator,
D(G(z)) is the discriminator's evaluation of the generated synthetic image data,
D(x) is the discriminator's evaluation of the original image data.

27. The training method according to claim 12, comprising
applying a regularization loss function between the distribution of the latent representation produced by the encoder referred to as the posterior p(z|x) and the distribution obtained by the latent variable, referred to as the prior p(z),
preferably wherein the regularization loss function includes the Wasserstein distance,
applying a perceptual loss function configured to capture a similarity between the original image and the generated synthetic image,
preferably wherein the perceptual loss function determines a loss between the activation of the original image data and the activation of generated synthetic image data.

28. (canceled)

29. The training method according to claim 12,
wherein training the system minimizes the loss function L_total:
$$L\_total = Lgen + Lreg + Lcritics + LWANg + Lperc$$
wherein:
Lreg=EMD (p(z|x), p(z)), which is the regularization loss,
Lperc=MSE (activations GI, activation OI), which is the perceptual loss,
LWGANg is the negative of the output of the critic while feeding on generated images, −D(G(z))
Lgen is the generation loss, i.e. =MSE (x, x′)
Lcritis is the critics loss, i.e. the distance between the distribution of original
image data and the distribution of generated synthetic image data,
MSE is the Mean Square Error function
EMD is the Wasserstein function
GI is the generated synthetic image
OI is the original image.

30. (canceled)

31. A computer program product comprising computer program code configured to carry out the training method according to claim 12 when executed by a processing unit.

32. A computer implemented method for compressing image data in a system according to claim 9, comprising:
providing an original image to the encoder,
encoding the original image by the encoder into a latent space representation,
estimating the parameters of the distribution in the latent representation space from which a latent variable is inferred,
generating a synthetic image by the generator from the latent variable, wherein the generated synthetic image represents a compressed version of the original image, and
storing the generated synthetic image or transmitting the generated synthetic image over a transmission network.

33. (canceled)

34. A computer program product comprising computer program code configured to carry out the method according to claim 32 when executed by a processing unit.
